(19) United States
(12) Patent Application Publication
(10) Pub. No.: US 2007/0173095 A1
(43) Pub. Date: Jul. 26, 2007

(54) Reusable block and fastener system

(76) Inventors: Rifael Bin-Nun, Teaneck, NJ (US); James K. Rasmusson, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/336,667

(22) Filed: Jan. 20, 2006

(51) Int. Cl. H01R 27/00

(52) U.S. Cl. 439/219

(57) ABSTRACT

A multi-piece children's toy includes a plurality of block members that are interconnected with connectors. The block members include one or more side faces, wherein at least one side face has an opening therein. The blocks may be made of a resilient foam material, and the connectors are configured to provide an interference fit with the openings in the block members to thereby interconnect the block members.

### BACKGROUND OF THE INVENTION

Various fasteners have been developed for interconnecting objects. In addition to conventional threaded fasteners and the like, various types of pins, dowels, and the like have been used to interconnect adjacent objects. Also, releasable connector arrangements for toy building blocks and the like have been developed.

Examples of connectors utilized for interconnecting cubes, blocks or the like are disclosed in Benton U.S. Pat. No. 1,428,206, Doak U.S. Pat. No. 1,895,611 and Wolf U.S. Pat. No. 3,672,681.

### SUMMARY OF THE INVENTION

One aspect of the present invention is a multi-piece children's construction toy including first and second build members. The first and second block members each define at least one side face, and each side face has a side surface with at least one opening therein. The at least one opening has an inner portion and an outer portion, the inner portion defining an inner cross-sectional shape having an inner cross-sectional area. The outer portion defines an outer cross-sectional shape having an outer cross-sectional area. The outer cross-sectional area of the opening is greater than the inner cross-sectional area. The construction toy further includes a connector member having first and second opposite end portions and an intermediate portion. The opposite end portions define an axis extending between therebetween. When assembled, the opposite end portions are received in the inner portions of the openings in the block members, and form an interference fit therewith that interconnects the first and second block members with the side surfaces thereof abutting one another. The intermediate portion of the connector member includes a stop portion or structure projecting outwardly in a direction that is transverse relative to the axis of the connector member. When assembled, the stop portion is received in the outer portions of the openings in the first and second block members.

Another aspect of the present invention is a multi-piece construction toy including a plurality of block members. Each of the block members has at least one side face with an opening therein defining a side wall surface. Each block member is made of a resilient material such as an open or closed-cell foam material. The construction toy further includes at least one connector made of a substantially non-resilient material and having opposite ends tightly received in the openings and deforming at least a portion of the side wall surface and forming an interference fit that holds the block members together with portions of the side faces abutting one another.

Yet another aspect of the present invention is a multi-piece structure including first and second members, each having at least one side face. Each side face has at least one opening therein defining a side wall surface. The openings in the first and second members have substantially the same cross-sectional shape and size. The multi-piece structure further includes a connector having first and second opposite ends having cross-sectional shapes that are substantially dissimilar to the cross-sectional shapes of the openings in the first and second members. The first opposite end is received in the at least one opening in the first member, and the second opposite end of the connector is received in the at least one opening in the second member. The opposite ends of the connector engage the side wall surfaces of the openings in the first and second members and interconnect the first and second members. At least a portion of the side faces of the first and second members abut one another.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially exploded isometric view of a construction toy according to one aspect of the present invention;

FIG. 2 is an isometric view of a block of the construction toy of FIG. 1;

FIG. 3 is a cross-sectional view showing the interference between the connectors and the openings in the block members;

FIG. 4 is a side elevational view of a block member;

FIG. 5 is a cross-sectional view of the block of FIG. 4 taken along the line V-V;

FIG. 6 is a cross-sectional view of two blocks interconnected by a connector;

FIG. 7 is an isometric view of a connector;

FIG. 8 is a side elevational view of a connector;

FIG. 9 is an end view of a connector;

FIG. 10 is a cross-sectional view of two block members interconnected by a connector according to another aspect of the present invention;

FIG. 11 is an isometric view of one of the blocks of FIG. 10;

FIG. 12 is an isometric view of the connector of FIG. 10;

FIG. 13 is a cross-sectional view of two block members interconnected by a connector according to another aspect of the present invention;

FIG. 14 is an isometric view of one of the blocks of FIG. 13; and

FIG. 15 is an isometric view of the connector of FIG. 13.

### DETAILED DESCRIPTION OF PREFERRED EMBODIMENT

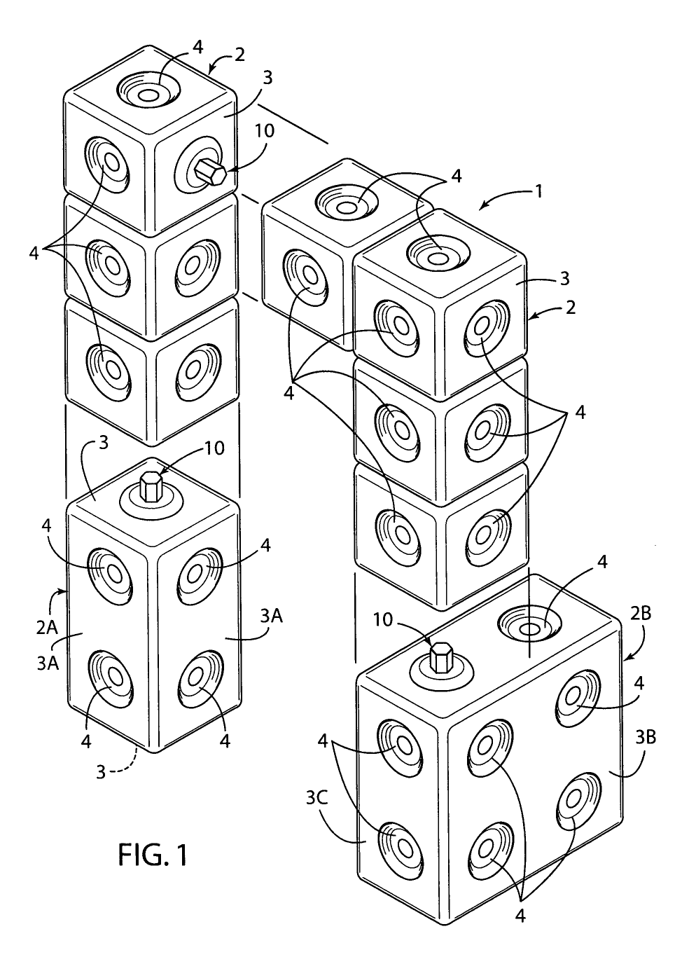

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

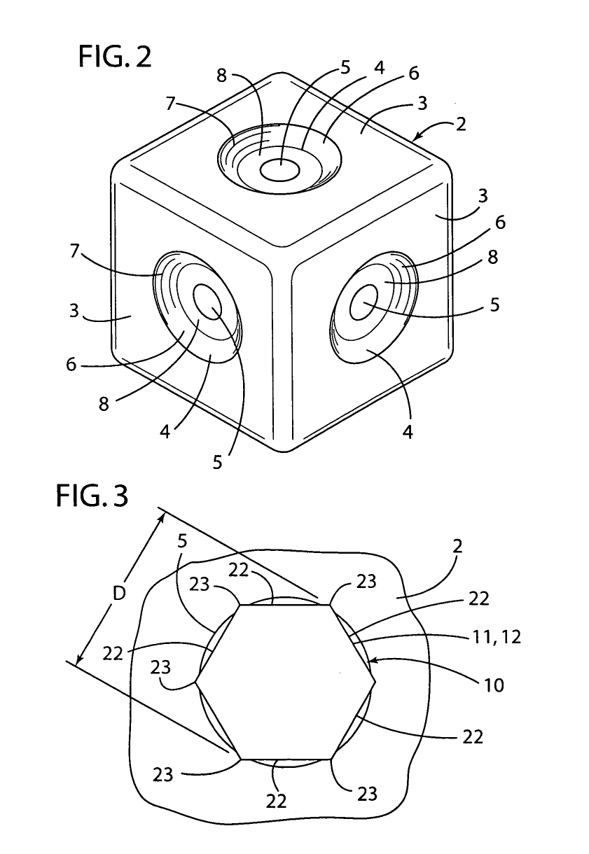

With reference to FIGS. 1 and 2, a multi-piece block and connector arrangement that may be utilized as children's construction toy 1 according to one aspect of the present invention includes a plurality of block members 2, 2A, 2B, etc. each having at least one side face 3. As discussed in more detail below, the block members may have a wide range of configurations. The side faces 3 have openings 4 having an inner portion 5 (see also FIG. 5) and an outer portion 6. The inner portion 5 has a cylindrical shape with a circular cross-sectional shape. The outer portion 6 of opening 4 has a circular cross-sectional shape with a radiused portion 7 that extends from a flat annular inner surface 8 to a side surface 9 of side face 3. The outer portions 6 of openings 4 have a substantially greater cross-sectional area than the cross-sectional area of inner portion 5 of openings 4.

Connector members 10 (FIGS. 7-9) are configured to quickly and easily interconnect block members 2, 2A, 2B in a wide range of configurations. Connector members 10 include a first end portion 11, and an opposite end portion 12 defining an axis “A” (FIG. 8). Connector members 10 include disk or washer-like intermediate portion 13 that projects transversely outwardly from a central portion 14 of connector 10. As illustrated in FIG. 6, when assembled, the intermediate portion 13 is positioned in the outer portions 6 of openings 4 in block members 2. The intermediate portion 13 includes a radiused edge portion 15 that has surface shape that closely corresponds to the surface of the radiused edge 7 of outer portion 6 of openings 4. Annular flat surface portions 16 and 17 of connector 10 fit closely against the flat annular surface 8 of openings 4 in blocks 2. As described in more detail below, the end portions 11 and 12 of connector 10 are received in the inner portions 5 of openings 4 and form a tight fit with the inner portions 5 of openings 4 to thereby interconnect adjacent block members 2.

With reference back to FIGS. 1 and 2, the multi-piece construction toy 1 may include a variety of blocks of different sizes, including cubes 2 having six orthogonal, square side faces. The construction toy 1 may also include a block 2A having four side faces 3A, each including two openings 4. It will be understood that the spacing between the openings 4 in side faces 3A of block 2A are spaced apart the same distance as openings 4 in a pair of adjacent interconnected blocks 2, and the height of block 2A (i.e. distance between side faces 3) is twice the dimension between side faces 3 of blocks 2. A larger block 2B may include a pair of side faces 3B, each having four openings 4, and the block 2B also includes a pair of side faces 3C, each having two openings 4. It will be readily apparent that additional blocks having larger numbers of openings 4 at equally spaced intervals may be utilized according to other aspects of the present invention. Also, objects of virtually any size or shape may be interconnected in substantially the same manner as blocks 2, and it will therefore be understood that the term “block”, as used herein is not limited to an object having a specific shape, size, etc. In the illustrated example, block 2 is a cube having dimensions of 1.375 inches×1.375 inches×1.375 inches. However, it will be understood that a variety of shapes and sizes of block members may be utilized.

With reference to FIGS. 5 and 6, block members 2 include inner passageways or openings 20 extending between opposite openings 4 in side faces 3. The inner passageways 20 provide for escape of air as a connector member 10 is inserted into opening 4. Inner portions 5 of openings 4 have cylindrical side surfaces 21 that extend inwardly from flat portions 8 of outer portions 6 of openings 4. Alternately, the cylindrical side surfaces 21 may extend through blocks 2, such that a smaller passageway 20 is not utilized. The block members 2 may be made of a resilient, compressible foam material having either open or closed cells.

With further reference to FIGS. 7-9, connector members 10 include end portions 11 and 12, each of which has a non-circular cross-sectional shape. In the illustrated example, the end portions 11 and 12 have a hexagonal cross-sectional shape including a plurality of flat side faces 22 extending parallel to the axis A and forming raised corners or ridges 23 at the intersections of planes 22. The intermediate portion 13 of connector 10 includes annular flat opposed surfaces 16 and 17 and radiused edge portion 15. The intermediate portion 13 extends outwardly and forms a disk or washer-like shape. The intermediate portion 13 is preferably integrally formed with the end portions 11 and 12. Connectors 10 are made of a substantially rigid material such as a polymer or other suitable material.

As illustrated in FIG. 6, when utilized to interconnect a pair of blocks, the ends 11 and 12 of connector 10 are received in the cylindrical inner portion 5 of openings 4, and the outwardly extending intermediate portion 13 is received in the outer portion 6 of openings 4. Intermediate portion 13 acts as a stop to protect connector 10 from being inserted all the way into an opening 4 in blocks members 2. When connector 10 is positioned in openings 4, end surfaces 24 and 25 of connector 10 are preferably spaced apart from annular surface 26 formed at the intersection between inner portion 5 of openings 4 and inner passageways 20. Also, the intermediate portion 13 of connector 10 is dimensioned to permit the side surfaces 9 of adjacent blocks 2 (and/or 2A, 2B, etc.) to contact one another when assembled. In the illustrated example, the outer surface 27 of intermediate portion 13 of connector 10 has substantially the same contour as the surface 28 of outer portion 6 of openings 4, such that there are substantially no gaps between the surfaces 27 and 28 when a pair of blocks are interconnected as shown in FIG. 6. However, it will be appreciated that the intermediate portion 13 may have a thickness and/or diameter that is somewhat smaller than the dimensions of surface 28 of outer portion 6 of opening 4 in blocks 2.

In use, an end portion 11 or 12 of a connector 10 is inserted into inner portion 5 of an opening 4 in a block member 2, preferably to a depth wherein intermediate portion 13 contacts the surface of outer portion 6 of opening 4. The end portions 11 and 12 of connector 10 are dimensioned to provide an interference fit with the inner portions 5 of openings 4. In one embodiment, the end portions 11 and 12 have a hexagonal cross-sectional shape as illustrated in FIG. 3, and the sum of the flat surfaces 22 (i.e., peripheral dimension) is the same as the circumference of inner portion 5 of opening 4. Alternately, the sum of the flat surfaces 22 may be less than the circumference of inner portion 5 to provide an interference fit requiring less force to assemble and/or disassemble, or the sum of flat surfaces 22 may be greater than circumference of inner portion 5 to provide an interference fit requiring more force to assemble and/or disassemble. Thus, the dimension “D” between the raised corners 23 is greater than the diameter of the inner portion 5 of opening 4 to thereby create an interference fit. Rather than the hexagonal cross-sectional shape shown in FIGS. 7-9, end portions 11 and 12 may have a circular cross-sectional shape, with a diameter that is slightly greater than the diameters of portions 5 of openings 4 to provide an interference fit. A wide range of cross-sectional shapes and configurations may be utilized. According to a preferred embodiment, the interfering portions of the connector ends 11, 12 and portions of openings 4 are in the range of about ten percent to about twenty-four percent of the area of the portions 5 of openings 4. It will be appreciated that FIG. 3 illustrates the inner portion 5 in an unstressed, free state prior to being deformed due to the interference with corners 23 of connector 10.

Because the construction toy is designed for use by children, the force required to insert connectors 10 into block members 2 is preferably quite small, in the range of about 3-4 ounces or less (e.g. 0.5-4 ounces or 1.0-4 ounces). This amount of force permits insertion of connectors 10 using only one hand (holding connector 10), without requiring that the other hand be used to hold block member 2. However, the amount of interference between connectors 10 and block members 2 may be somewhat greater, such that up to about one pound of force is required to insert connectors 10 into block members 2. If a force larger than about 4 ounces is required, two-handed assembly is typically required. Many (if not most) assemblies formed by block members 2 and connectors 1 result in structures tending to place primarily shear loads on connectors 10. The block-to-block connection is generally quite strong in shear compression relative to the tensile strength of the connection. Thus, even if the block-to-block connection is weak in tension due to a small amount of interference between block members 2 and connectors 10, the structure will be relatively strong, yet still disassemble easily.

As discussed above, the connector 10 is preferably made of a substantially rigid material, and the block members 2 are made of a resilient foam material. The material of the blocks 2 is deformed (e.g. stretched and/or compressed) relatively easily, such that the connectors 10 can be manually inserted by a child without use of a large force. The shape and size of the end portions 11 and 12 of connector 10 and openings 4 provide a predetermined amount of force for assembly of the blocks 2. The blocks 2 are preferably made of a resilient foam material that returns to is original shape and size upon removal of connectors 10. Although blocks 2 may be made from a wide variety of known foam materials, the illustrated block members 2 are made of a closed cell flexible expanded polyurethane foam having a density of about three to nine pounds per cubic foot, or more preferably four to eight pounds per cubic feet, and still more preferably about five to seven pounds per cubic feet, and most preferably about six pounds per cubic foot. In a preferred method of fabricating block members 2, an auxiliary blowing agent such as Freon, HCFC, or CFC is utilized, and the blocks are formed in a closed mold heated to about 110° F. Under these conditions, the foam sees about ten percent compression relative to its free-rise density. The mold preferably has a highly polished surface finish, and a blowing agent such as C-11 is utilized to provide a thin, integral skin on the block members 2. The block members may have a wide range of hardness. In a preferred embodiment, the skin of the block members has a hardness rating of about 20 on the Shore OO scale to ensure that the connectors 10 provide a relatively snug grip or purchase on the inside surfaces 21 of openings 4. The core of the block members (i.e. the material away from openings 4) is primarily for filling purposes, and could therefore have a hardness rating of 10 or less on the Shore OO scale. In a preferred embodiment, the foam material of block members 2 has a resilience corresponding to a laboratory Ball Rebound test wherein a sample ball rebounds to at least about forty-five percent of its release height.

If a large force is applied to a structure formed from a number of blocks 2 and connectors 10, the foam material of the blocks 2 will deform thereby causing the ends 11 and 12 of connectors 10 to slide out of the openings 4 or causing the blocks to deform and fold. In this way, the blocks 2 and connectors 10 can be configured to stay together if a small load is applied, yet still pull apart if a relatively large load is applied.

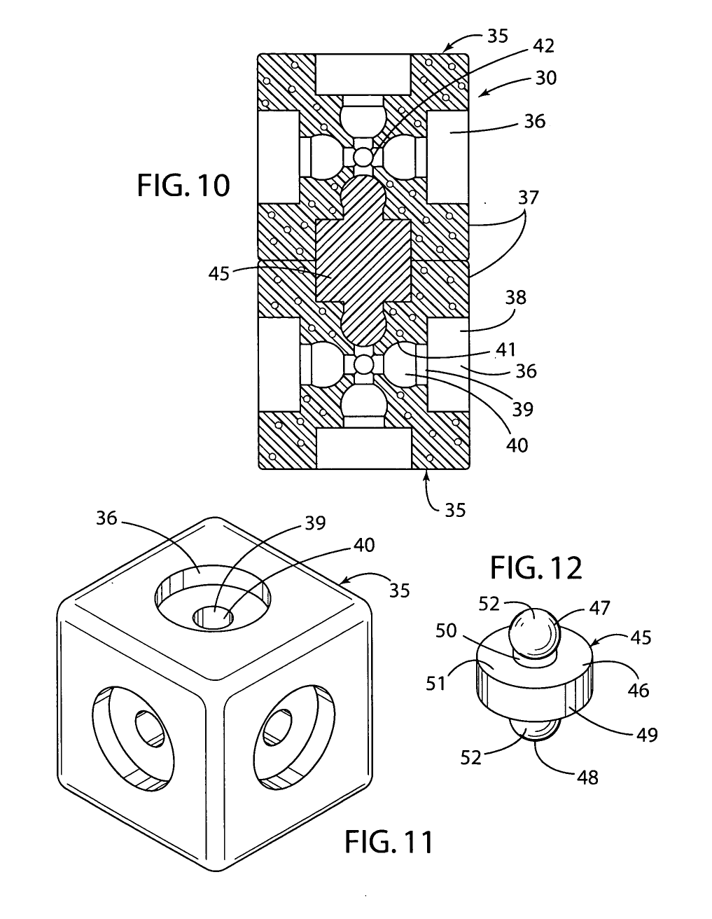

With further reference to FIGS. 10-12, a multi-piece construction toy 30 according to another aspect of the present invention includes a plurality of foam blocks 35 having openings 36 in side faces 37 of blocks 35. Openings 36 include a cylindrical outer portion 38, a cylindrical intermediate portion 39, and an inner portion 40 having a spherical side wall 41. Inner passageways 42 extend between opposite openings 36. A connector 45 is made of a polymer or other suitable material, and includes an intermediate portion 46 that projects outwardly from end portions 47 and 48. In the illustrated example, the intermediate portion 46 is disk-shaped, with a cylindrical outer surface 49. A cylindrical portion 50 extends between flat surface 51 of intermediate portion 46 and spherical outer surface 52 of end portions 47 and 48.

In use, foam blocks 35 are interconnected by a connector 45 that is inserted into openings 36. The spherical end portions 47 and 48 of connector 45 have a diameter that is greater than the diameter of the cylindrical intermediate portion 39 of openings 36. As the connectors 45 are inserted into openings 36, the foam material forming cylindrical intermediate surface 39 is deformed until the spherical ends 47 and 48 are fully inserted into the inner portion 40 of opening 36. The connectors 45 and openings 36 thereby provide an arrangement that permits a number of blocks 35 to be readily assembled and/or dissembled in a desired configuration. The amount of force required to fully insert the connector 45 in opening 36 can be controlled by increasing or decreasing the diameter of the cylindrical intermediate portion 39, and/or changing the shape of intermediate portion 39. For example, intermediate portion 39 could have a surface that is generally cylindrical with a plurality of raised ridges extending parallel to the axis of opening 36 to thereby reduce the amount of force required to insert connector 45 in openings 36.

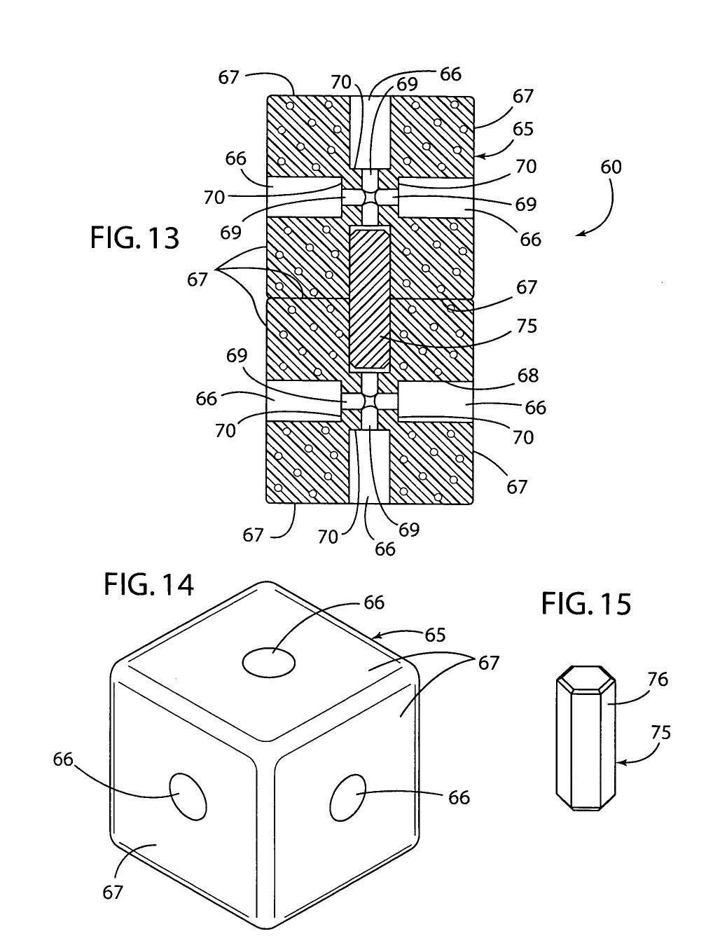

With further reference to FIGS. 13-15, a multi-piece construction toy 60 according to another aspect of the present invention includes a plurality of foam blocks 65 having openings 66 in side faces 67 of blocks 65. Openings 66 include a cylindrical, larger outer portion 68 and a cylindrical, smaller through-hole 69, forming an annular flat ring-like surface 70. Connectors 75 include a plurality of flat side faces 76 forming a hexagonal cross-sectional shape. Alternately, connectors 75 could be cylindrical or have spherical ends such as ends 47 and 48 of connector 45 described above.

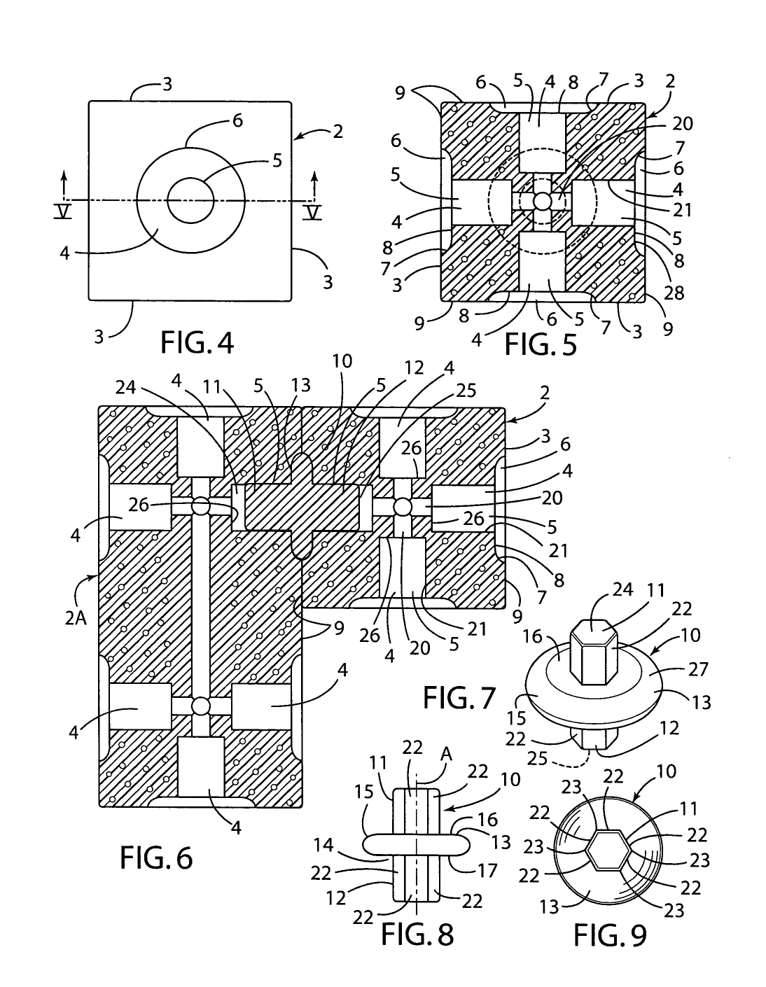

In use, the connectors 75 are inserted into the cylindrical outer portion 68 of openings 66 to interconnect block members 65. The annular surface 70 acts as a stop and thereby ensures that the connectors 75 are not inserted all of the way into a block member 65. Through-holes 69 provide for escape of air as the connector 75 is inserted into openings 66. The connector 75 may have a cross-sectional shape and size that is substantially similar to the shape and size of the opposite end portions 11 and 12 of connector 10 discussed in detail above in connection with FIGS. 7-9. Also, connector blocks 65 may be made of a resilient foam material as discussed in more detail above in connection with block members 2 (FIGS. 1-6).

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A multi-piece children's construction toy, comprising:
first and second block members, each defining at least one side face, each side face having a side surface with at least one opening therein having an inner portion and an outer portion, the inner portion defining an inner cross-sectional shape having an inner cross-sectional area, the outer portion defining an outer cross-sectional shape having an outer cross-sectional area, and wherein the outer cross-sectional area is greater than the inner cross-sectional area; and
a connector member having first and second opposite end portions defining an axis extending between the end portions and an intermediate portion, and wherein the opposite end portions are received in the inner portions of the openings in the block members, and form an interference fit therewith that interconnects the first and second block members with the side surfaces of the first and second block members abutting one another, and wherein the intermediate portion of the connector member includes a stop portion projecting outwardly in a direction that is transverse relative to the axis, and wherein the stop portion is received in the outer portions of the openings in the first and second block members.

2. The children's construction toy of claim 1, wherein:
the opposite end portions of the connector have substantially the same cross-sectional shape and size.

3. The children's construction toy of claim 2, wherein:
the stop portion comprises an annular flange-like structure that is integrally formed with the first and second opposite end portions.

4. The children's construction toy of claim 3, wherein:
the flange-like structure has a circular outer peripheral edge.

5. The children's construction toy of claim 4, wherein:
the flange-like structure includes spaced-apart parallel surfaces extending radially outwardly.

6. The children's construction toy of claim 5, wherein:
the flange-like structure includes a smoothly curved peripheral edge surface; and
the outer portions of the openings in the block members fit closely against the flange-like structure of the connector.

7. The children's construction toy of claim 1, wherein:
the inner portions of the openings in the block members define a cylindrical inner surface, and
the opposite end portions of the connector have a non-circular cross-sectional shape.

8. The children's construction toy of claim 7, wherein:
the opposite end portions of the connectors have a polygonal cross-sectional shape.

9. The children's construction toy of claim 1, wherein:
the block members are made of a resilient material, and the connectors are made of a substantially rigid material.

10. The children's construction toy of claim 1, wherein:
the side surfaces include substantially flat portions abutting one another.

11. The children's construction toy of claim 1, wherein:
the first and second block members have at least six side faces, each side face comprising a substantially flat surface portion and an opening.

12. The children's construction toy of claim 11, wherein:
all of the side faces of each block member are orthogonal relative to one another.

13. The children's construction toy of claim 12, wherein:
at least two of the side faces of each block have at least two openings therein.

14. The children's construction toy of claim 1, wherein:
the inner portions of the openings define inner surfaces that are orthogonal to the side surfaces.

15. A multi-piece construction toy, comprising:
a plurality of block members, each having at least one side face, each side face having an opening therein defining a sidewall surface, each block member being made of a resilient foam material; and
at least one connector made of a substantially non-resilient material relative to the resilient foam material of the block members, the connector having opposite ends tightly received in the openings and deforming at least a portion of the sidewall surface and forming an interference fit that holds the block members together with portions of the side faces abutting one another.

16. The multi-piece construction toy of claim 15, wherein:
the resilient foam material comprises a closed cell compressible foam.

17. The multi-piece construction toy of claim 15, wherein:
the openings in the block members define circular cross-sectional shapes;
the opposite ends of the at least one connector have non-circular cross-sectional shapes.

18. The multi-piece construction toy of claim 17, wherein:
the openings define cylindrical sidewall surfaces when the sidewall surfaces are in an unstressed free state;
the opposite ends of the at least one connector include raised edges in tight contact with the sidewall surfaces and deforming the sidewall surfaces into a non-cylindrical shape.

19. The multi-piece construction toy of claim 15, wherein:
the openings include an inner portion having a first cross-sectional area and an outer portion having a second cross-sectional area that is substantially greater than the first cross-sectional area; and wherein:
the at least one connector includes an outwardly extending integral flange-like stop structure positioned in the outer portions of the openings in the first and second block members.

20. The multi-piece construction toy of claim 19, wherein:
the inner and outer portions of the at least one opening have circular cross-sectional shapes; and
the flange-like stop structure has a circular peripheral edge.

21. The multi-piece structure of claim 19, wherein:
the flange-like stop structure includes opposite side surfaces contacting the first and second block members.

22. The multi-piece structure of claim 15, wherein:
the connector defines first and second opposite ends and an axis extending therebetween, the connector further including a plurality of ridge-like portions on the outer surfaces extending parallel to the axis.

23. The multi-piece construction toy of claim 15, wherein:
the connector has a substantially uniform cross-sectional shape.

24. The multi-piece construction toy of claim 15, wherein:
the resilient foam material has a density in the range of about four to six pounds per cubic foot.

25. The multi-piece construction toy of claim 24, wherein:
the foam material includes an integral skin.

26. A multi-piece structure, comprising:
first and second members made of a first material defining a first hardness, each of the first and second members having at least one side face, each side face having at least one opening therein defining a sidewall surface, wherein the sidewall surfaces of the openings in the first and second members have substantially the same shape and size, and at least a portion of the side faces of the first and second members abut one another;
a connector made of a second material defining a second hardness that is substantially greater than the first hardness, the connector having first and second opposite ends with outer surfaces defining shapes that are substantially dissimilar to the shapes of the sidewall surfaces of the openings in the first and second members, the first opposite end received in the at least one opening in the first member, the second opposite end received in the at least one opening in the second member, the outer surfaces of the opposite ends engaging the sidewall surfaces of the at least one openings in the first and second members and deforming portions of the sidewall surfaces and forming and interference fit and interconnecting the first and second members.

27. The multi-piece structure of claim 26, wherein:
the opposite ends of the connector form a tight interference fit with the sidewall surfaces of the at least one openings.

28. A multi-piece children's toy, comprising:
first and second block members, each having a plurality of side faces and at least one aperture in each side face having sidewall surfaces defining a perimeter in an unstressed state, each aperture further defining a first cross-sectional area, wherein the first and second block members are made of a resilient foam material; and
a connector made of a polymer material that is substantially rigid relative to the resilient foam material, the connector having opposite end portions received in selected ones of the apertures in the first and second block members, the opposite end portions having interfering portions extending beyond the perimeters of the apertures in the block members, wherein the cross-sectional area of the interfering portions is in the range of about ten percent to about twenty-four percent larger than the first cross-sectional area.

29. The multi-piece children's toy of claim 28, wherein:
the apertures and the opposite ends of the connector have cylindrical surfaces.

30. The multi-piece children's toy of claim 28, wherein:
the connector includes a transversely extending stop structure between the opposite ends and preventing insertion of the connector beyond a point at which the stop structure contacts a selected one of the first and second block members.
